(19) United States
(12) Patent Application Publication
(10) Pub. No.: US 2013/0156440 A1
(43) Pub. Date: Jun. 20, 2013

(54) WIRELESS COMMUNICATION NETWORK SYSTEM AND OPTICAL-ELECTRICAL CONVERSION MODULE

(71) Applicant: KUO-FONG TSENG, Tu-Cheng (TW)

(72) Inventor: KUO-FONG TSENG, Tu-Cheng (TW)

(73) Assignee: HON HAI PRECISION INDUSTRY CO., LTD., Tu-Cheng (TW)

(21) Appl. No.: 13/552,646

(22) Filed: Jul. 19, 2012

(30) Foreign Application Priority Data
Dec. 16, 2011 (TW) 100146930

(51) Int. Cl. H04B 10/10

(52) U.S. Cl. 398/127

(57) ABSTRACT

A wireless communication network system includes a signal source terminal, a user terminal, an electrical-optical conversion module, and an optical-electrical conversion module. The electrical-optical conversion module electrically connects with the signal source terminal, for receiving electrical signals sent by the signal source terminal and converting the electrical signals into optical signals. The optical-electrical conversion module electrically connects with the user terminal, for receiving the optical signals and converting the optical signals into electrical signals. The signal source terminal, the user terminal, the electrical-optical conversion module and the optical-electrical conversion module cooperatively build, define, or form a wireless optical communication network.

### BACKGROUND

1. Technical Field

The present disclosure generally relates to a wireless communication network system and an optical-electrical conversion module for the wireless communication network system.

2. Description of Related Art

Many medical precision instruments are employed in hospitals, for facilitating medical check-ups or monitoring the vital signs of the patients. However, during use, these medical precision instruments are easily affected or may be interfered with by the external electromagnetic waves. Since the wireless router of a traditional wireless network may emit radio frequency signals (including the electromagnetic waves) during use, thus, the traditional wireless network may not be employed in the hospital.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 shows a schematic view of an embodiment of a wireless communication network system.

FIG. 2 shows a functional block diagram of the wireless communication network system.

### DETAILED DESCRIPTION

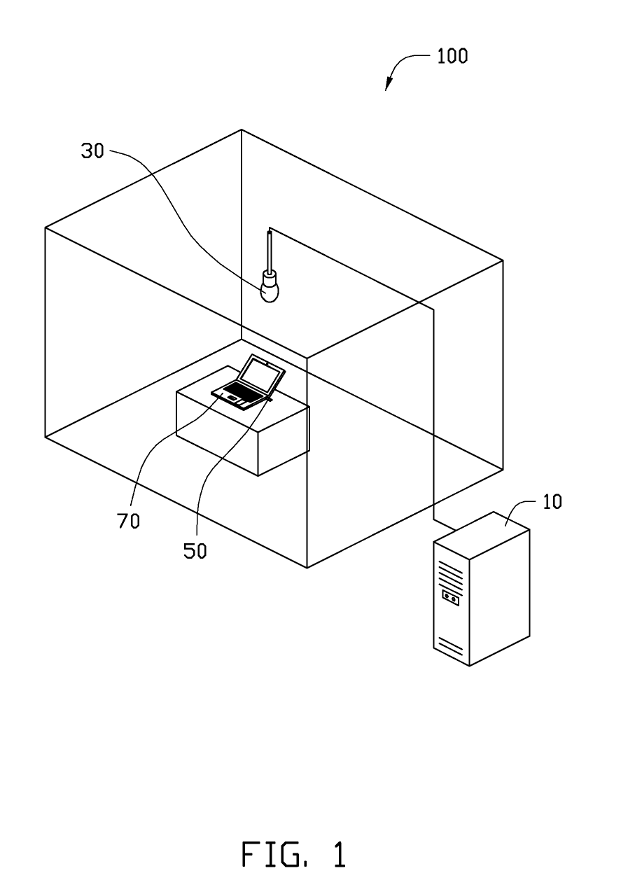

FIG. 1 is an embodiment of a wireless communication network system 100. The wireless communication system 100 includes a signal source terminal 10, an electrical-optical conversion module 30, an optical-electrical conversion module 50, and an user terminal 70. The electrical-optical conversion module 30 is electrically connected with the signal source terminal 10, for receiving one or more electrical signals sent from the signal source terminal 10 and converting the electrical signals into optical signals. The optical-electrical conversion module 50 is electrically connected with the user terminal 70, for receiving the optical signals and converting the optical signals into one or more electrical signals. The signal source terminal 10, the user terminal 70, the electrical-optical conversion module 30 and the optical-electrical conversion module 50 cooperatively define a wireless optical communication network, thereby providing communication between the signal source terminal 10 and the user terminal 70.

In the illustrated embodiment, the signal source terminal 10 is a wireless network base station. The signal source terminal 10 may also a host computer, a server, or an outer network connecting platform.

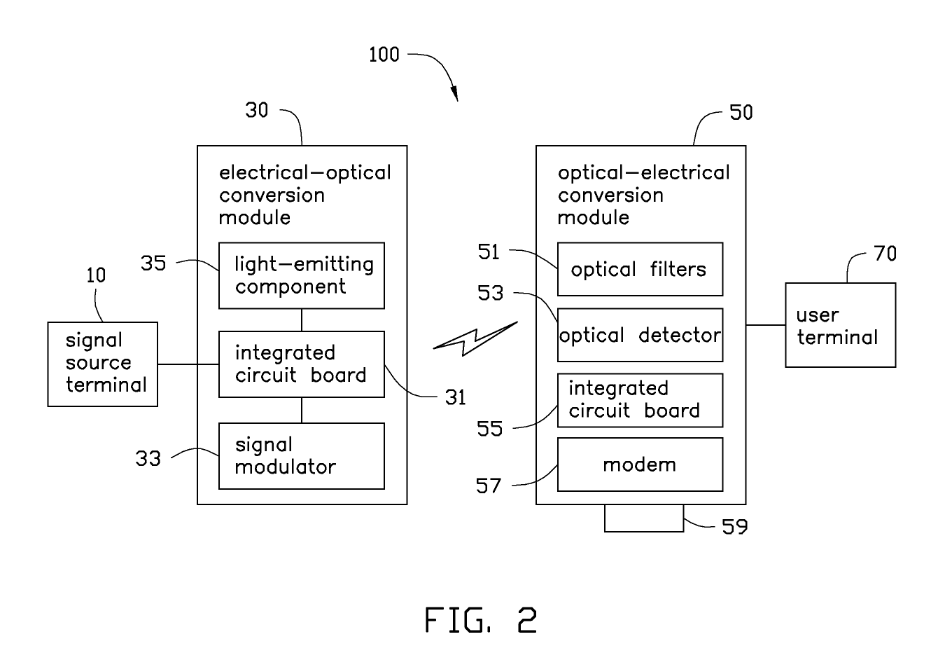

FIG. 2, illustrates the electrical-optical conversion module 30 of the embodiment of the wireless communication system 100. The electrical-optical conversion module 30 includes an integrated circuit board 31, a signal modulator 33, and a light-emitting component 35. The integrated circuit board 31 is electrically connected with the signal source terminal 10. The signal modulator 33 is electrically connected with the integrated circuit board 31 and the light-emitting component 35. The signal modulator 33 is configured for receiving and modulating the electrical signals sent from the signal source terminal 10, and further converting the modulated electrical signals into a plurality of high-speed digital electrical signals. In the illustrated embodiment, the electrical-optical conversion module 30 is also configured to have illuminating function, namely, the electrical-optical conversion module 30 may also be used as an illuminator. As in use, the electrical-optical conversion module 30 is generally mounted to a rooftop or at a high position on a wall away from the ground floor. The light-emitting component 35 is electrically connected with the integrated circuit board 31 and the signal modulator 33 for emitting light and optical signals. The light-emitting component 35 in this embodiment is a light-emitting diode (LED) lamp. In some embodiments, the light-emitting component 35 can also be a laser lamp.

The optical-electrical conversion module 50 is a portable plug and play device, having a shape similar to a U-disk device. The optical-electrical conversion module 50 is electrically connected with the user terminal 70, for receiving optical signals converted from the electrical-optical conversion module 30, and converting the received optical signals into electrical signals.

In the illustrated embodiment, the optical-electrical conversion module 50 includes an optical filter 51, an optical detector 53, an integrated circuit board 55, a modem 57, and an electrical connector 59. The optical filter 51 is configured for filtering the received optical signals to obtain a plurality of specified or predefined optical signals having particular or specified waveform, such as a plurality of LED optical signals. The optical detector 53 is electrically connected with the integrated circuit board 55, for detecting the aforementioned optical signals filtered by the optical filter 51, and converting the predefined or specified optical signals into a plurality of high-speed digital electrical signals. The modem 57 is also electrically connected with the integrated circuit board 55, for receiving the high-speed digital electrical signals and converting the high-speed digital electrical signals into a plurality of analog signals. The electrical connector 59 is an USB connector in the illustrated embodiment, for electrically connecting with the modem 57.

The user terminal 70 is a notebook computer in the illustrated embodiment, and is electronically connected with the optical-electrical conversion module 50 by the electrical connector 59, during usage. The user terminal 70 is configured for receiving the electrical signals sent from the optical-electrical conversion module 50, thereby establishing wireless communication between the signal source terminal 10 and the user terminal 70.

In use, the optical-electrical conversion module 50 is electrically connected to the user terminal 70, the signal source terminal 10, the electrical-optical conversion module 30, the optical-electrical conversion module 50, and the user terminal 70 cooperatively forming a wireless communication network, for transmitting signals between the signal source terminal 10 and the user terminal 70. The electrical signals sent from the signal source terminal 10 are transmitted to the electrical-optical conversion module 30. The signal modulator 33 of the electrical-optical conversion module 30 receives and modulates the electrical signals sent from the signal source terminal 10, and further converts the modulated electrical signals into the high-speed digital electrical signals. The light-emitting component 35 is configured to emit light and optical signals. The light-emitting component 35 is capable of converting the high-speed digital electrical signals into a plurality of high-speed optical signals. The optical filter 51 of the optical-electrical conversion module 50 filters the optical signals sent out by the light-emitting component 35. The optical detector 53 detects the predefined or specified optical signals filtered by the optical filter 51, and converts the predefined or specified optical signals into a plurality of high-speed digital electrical signals. The modem 57 then receives the high-speed digital electrical signals and converts the high-speed digital electrical signals into a plurality of analog signals for being received by the user terminal 70.

While various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A wireless communication network system comprising:
a signal source terminal;
an electrical-optical conversion module electrically connecting with the signal source terminal, for receiving one or more electrical signals sent from the signal source terminal and converting the one or more electrical signals into one or more optical signals;
an optical-electrical conversion module; and
a user terminal electrically connecting with the optical-electrical conversion module, wherein the optical-electrical conversion module is configured for receiving the one or more optical signals and converting the optical signals into one or more electrical signals; the signal source terminal, the user terminal, the electrical-optical conversion module and the optical-electrical conversion module cooperatively define a wireless optical communication network, thereby providing communication between the signal source terminal and the user terminal.

2. The wireless communication network system of claim 1, wherein the electrical-optical conversion module comprises an integrated circuit board, a signal modulator, and a light-emitting component; the integrated circuit board is electrically connected with the signal source terminal, the signal modulator electrically is connected with the integrated circuit board for receiving and modulating the one or more electrical signals sent from the signal source terminal, and further converting the modulated electrical signals into one or more high-speed digital electrical signals; the light-emitting component is electrically connected with the integrated circuit board and the signal modulator for emitting one or more light and optical signals.

3. The wireless communication network system of claim 2, wherein the optical-electrical conversion module comprises an optical detector, an integrated circuit board and a modem; the optical detector is electrically connected with the integrated circuit board, for detecting the optical signals, and converting the optical signals into a plurality of high-speed digital electrical signals; the modem is electrically connected with the integrated circuit board, for receiving the high-speed digital electrical signals and converting the high-speed digital electrical signals into a plurality of analog signals and sending the analog signals to the user terminal

4. The wireless communication network system of claim 3, wherein the optical-electrical conversion module is a portable plug and play device.

5. The wireless communication network system of claim 3, wherein the optical-electrical conversion module further comprises an optical filter configured for filtering the received optical signals before the optical signals are being sent to the optical detector.

6. The wireless communication network system of claim 1, wherein the light-emitting component is a light-emitting diode lamp.

7. The wireless communication network system of claim 1, wherein the signal source terminal is a wireless network base station selected from a group consisting of a host computer, a server, and an outer network connecting platform.

8. An optical-electrical conversion module for receiving one or more optical signals and converting the one or more optical signals into one or more electrical signals, comprising:
an integrated circuit board;
an optical detector, the optical detector electrically connects with the integrated circuit board, for detecting the one or more optical signals, and converting the one or more optical signals into one or more high-speed digital electrical signals; and
a modem electrically connects with the integrated circuit board, for receiving the one or more high-speed digital electrical signals and converting the one or more high-speed digital electrical signals into one or more analog signals and sending the analog signals to a user terminal.

9. The optical-electrical conversion module of claim 8, wherein the optical-electrical conversion module is a portable plug and play device.

10. The optical-electrical conversion module of claim 8, further comprising an optical filter configured for filtering the received optical signals before the optical signals are being sent to the optical detector.

11. The optical-electrical conversion module of claim 10, further comprising an electrical connector, the electrical connector electrically connecting with the modem.

12. The optical-electrical conversion module of claim 11, wherein the electrical connector is an USB connector.
